(19) United States
(12) Patent Application Publication
(10) Pub. No.: US 2008/0301636 A1
(43) Pub. Date: Dec. 4, 2008

(54) Per-instance and per-class aspects

(75) Inventor: Kabir Khan, London (GB)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Red Hat, Inc.

(21) Appl. No.: 11/809,429

(22) Filed: May 31, 2007

(51) Int. Cl. G06F 9/44

(52) U.S. Cl. 717/118

(57) ABSTRACT

An object-oriented program development tool supports the specification and implementation program aspects. Cross-cutting concerns can be identified, and key points in a program augmented with arbitrary functionality. Classes and individual objects can be associated with different advices. Interceptors can be added dynamically on a per-instance and/or a per-class basis.

### FIELD

The invention relates to object-oriented programming language functionality. More specifically, the invention concerns implementation methods for per-instance and per-class aspects.

### BACKGROUND

Object-oriented programming (“OOP”) tools and techniques have brought many benefits to software engineers. Expressive type rules, precise scoping, and other advanced features permit robust applications to be developed quickly, and facilitate the design of reusable code. Many different programming languages have been designed or extended to include OOP features. Popular, widely-used object-oriented languages include Java and C++.

Object-oriented (“OO”) languages provide powerful features for expressing relationships among pieces of data, and the operations that can properly be carried out on that data. The central element in an OO system is the object, an aggregation of data and functions that usually represents a real or abstract thing or process. Objects have a type or “class” that describes the data that each instance of the class has, and the “methods” that an instance can perform. Classes are often organized hierarchically into one or more trees. Some languages (e.g., Java, Perl) treat classes themselves as another type of object, so a program can examine and manipulate its own structure.

Although OO languages are good for expressing and manipulating information related to the ultimate disposition of a real-world problem, there often arise tasks that are related to the application as a computer program, without regard to any particular type of object or method. A simple example of such a task is logging: suppose it is desired to record certain actions of the program for testing, debugging, or another purpose. Traditionally, one might add logging statements to each object method to be traced, but this clutters the functional code of the object with logically unrelated material. Furthermore, the approach lacks flexibility: it is difficult to provide an interface to control the logging without complicating other aspects of the object's interfaces. Even worse, mixing unrelated functionality into an object reduces the object's potential for re-use, because (in the current example) a prospective user may not need logging at all, or may need a different sort of logging.

The logging example discussed above is an instance of a “cross-cutting concern:” functionality that is orthogonal to a principal purpose of an object or method. Orthogonality, in this context, means that the cross-cutting functionality may not affect the logical operation of objects in a program—the program may function identically whether or not the cross-cutting concern is active, and it may make sense to apply the cross-cutting functionality to several unrelated classes.

Aspect-oriented programming (“AOP”) tools and techniques provide improved mechanisms to express and manage cross-cutting concerns. However, the AOP paradigm is still relatively new, and available tools lack sophistication. To realize more of AOP's promise, new development tool functionality is needed.

### SUMMARY

Embodiments of the invention manipulate an input object-oriented code to produce an output code that includes extra instructions to implement cross-cutting concerns.

### BRIEF DESCRIPTION OF DRAWINGS

Embodiments of the invention are illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

FIG. 1 shows an overview of a first compilation process where an embodiment of the invention can operate.

FIG. 2 shows an overview of a second compilation process where an embodiment of the invention can operate.

FIG. 3 shows some features of a sample object class and objects.

FIG. 4 is a flow chart that outlines operations according to an embodiment of the invention.

FIG. 5A shows an “object-oriented” view of object interactions.

FIG. 5B shows what occurs within a computer system when objects interact.

FIG. 5C shows how object interaction may change when an embodiment of the invention is applied.

FIG. 6A shows an ordinary subroutine call.

FIGS. 6B and 6C show two different approaches to modifying a method invocation according to embodiments of the invention.

FIG. 7 is a flow chart of another embodiment of the invention.

FIG. 8 is a flow chart detailing operations of a portion of an embodiment of the invention.

FIG. 9 shows several Java source code fragments to illustrate modifications made by an embodiment of the invention.

### DETAILED DESCRIPTION

Embodiments of the invention include software development tools and run-time support libraries to describe and implement cross-cutting concerns in object-oriented programs. The tools and libraries make up a fully fledged Application Program Interface (“API”) for adding Aspect-Oriented Programming (“AOP”) artifacts to a given class or instance of the class. Each class is represented by a domain, and every instance of the class occupies a sub-domain. Embodiments permit bindings and interceptors to be added statically or dynamically on both per-instance and per-class bases.

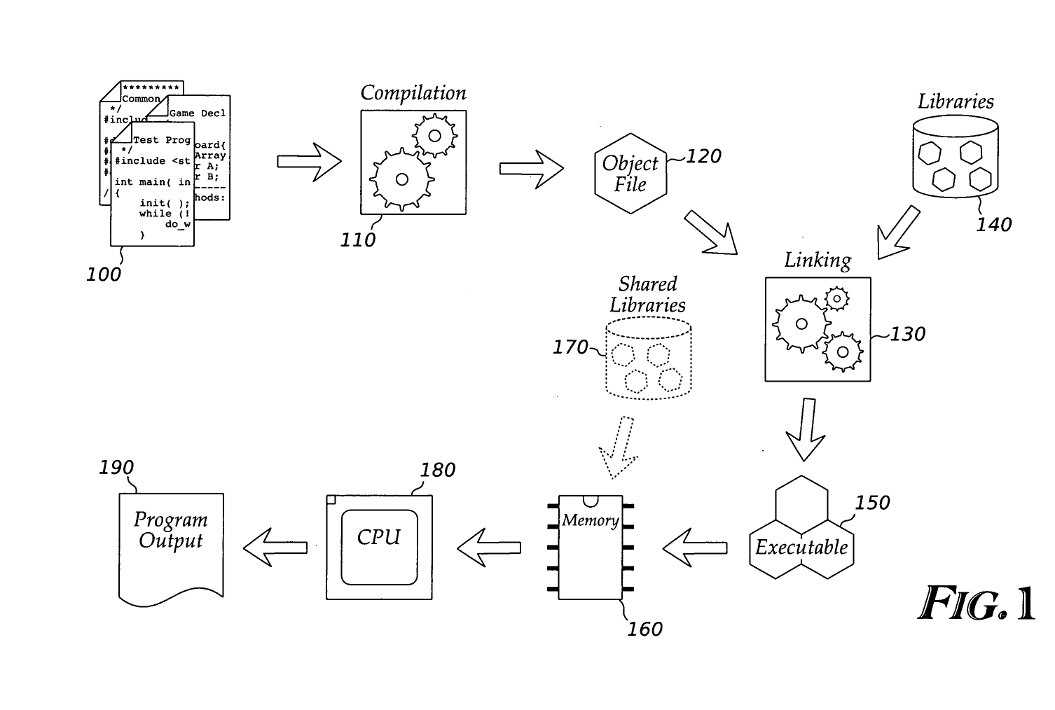

FIG. 1 shows a general overview of the process of creating and executing a program. One or more program source files 100 are passed through a compilation process 110 to produce an object file 120. The object file (and perhaps other object files, not shown) is subjected to a linking process 130, where the information may be combined with similar information from libraries 140 to produce an executable 150. Executable 150 typically contains data and instructions to cause a programmable processor to perform operations originally described in source files 100. Executable 150 is loaded into a memory 160 of a computer, where a programmable processor 180 (central processing unit or “CPU”) processes it to produce a desired effect (e.g., program output 190). Programs written in the C++ language follow this model.

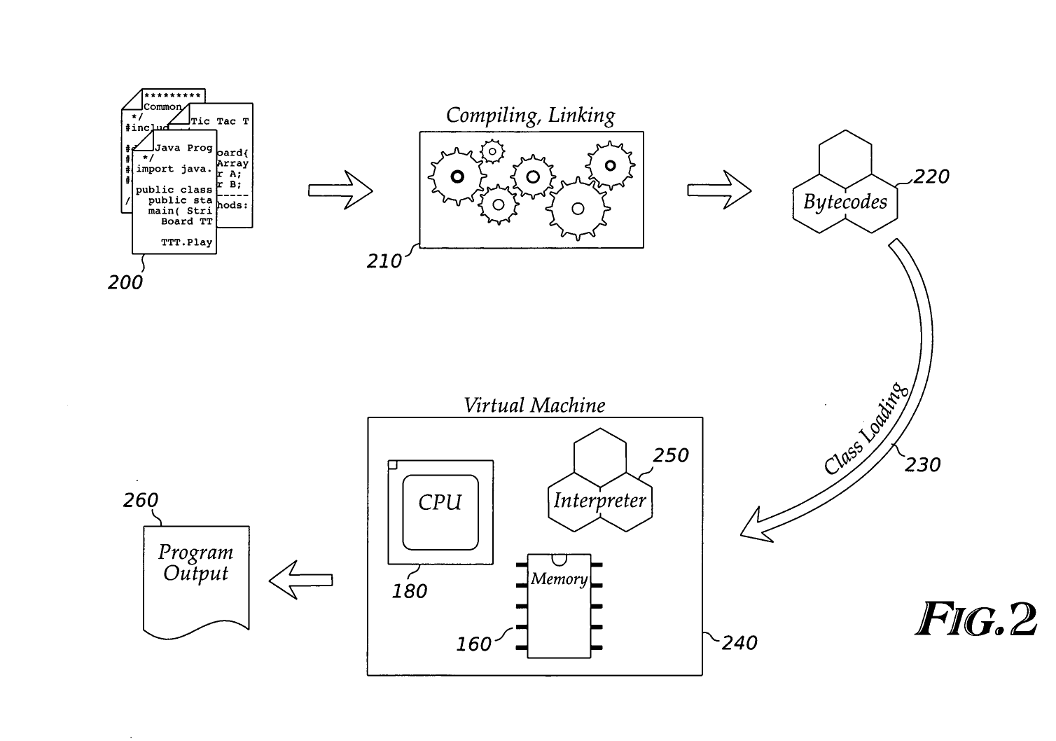

FIG. 2 shows an overview of a similar process that occurs with some programming languages. Here, program source files 200 undergo a combined compilation and linking process 210 to produce bytecodes 220. These are conceptually similar to the data and instructions of executable 150, but they may not be suitable for direct execution by a programmable processor. Instead, they may be loaded into a virtual machine 240, which is made up of an interpreter 250, memory 160 and CPU 180. Virtual machine 240 emulates a programmable processor that can execute bytecodes 220, producing as an eventual result program output 260. Java programs are prepared and executed this way.

In the processes outlined with reference to FIGS. 1 and 2, the input source codes (100, 200) describe data types, express relationships between data fields and the operations that can be performed on the data, and specify how those operations should be combined to achieve the program's purpose. Much of the material in a source program is non-functional: it does not translate directly into instructions to cause the programmable processor to perform any operation. Instead, it expresses information about the data the program is to manipulate, such as the operations that do and do not make sense to perform with the data. For example, a programmable processor may be capable of adding a first number representing a temperature to a second number representing a street address. This is a nonsensical operation, though, so the source codes may provide information so that the various code processing steps (i.e., compiling, linking) can identify and prevent an attempt to perform such an operation. As source code is transformed into executable code, non-functional information tends to be removed, leaving only functional instructions that are guaranteed to perform only sensible operations (to the extent that those operations can be—and are—described in the original source language).

Embodiments of the invention allow a developer to identify key points in a program (also called “joinpoints”) through a mechanism that is not necessarily tied to the type or class system of a source language, and to have arbitrary operations performed if an identified key point is encountered during the execution of the program. An embodiment can operate at any phase in the compile/link/load/execute cycles outlined in FIGS. 1 and 2 where the key points can still be identified. One embodiment may operate as a pre-compiler phase, reading the source code programs and emitting modified source code. One embodiment may modify object code before it is linked to produce an executable. One embodiment may modify bytecodes as they are loaded into a virtual machine for execution.

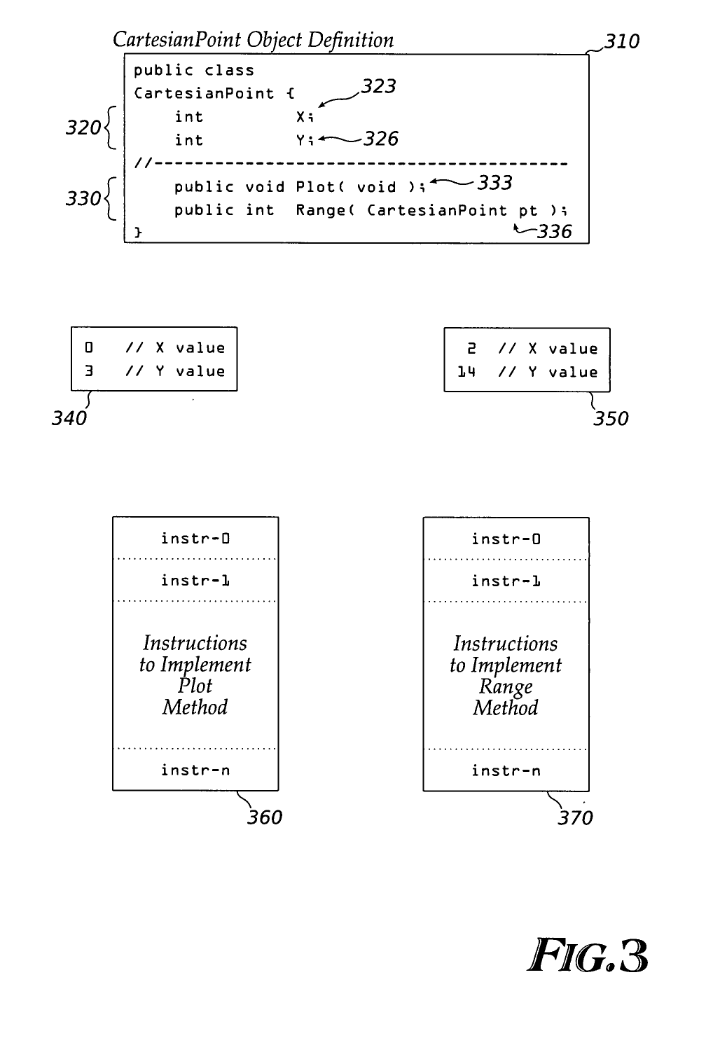

FIG. 3 shows some features of a class that might be used in an object-oriented program. The class declaration 310 shows the two basic sorts of information an OO system maintains about an object: its data fields 320 and its methods 330. Each instance of a CartesianPoint object will have its own X and Y coordinates (323, 326), and every CartesianPoint object will be able to draw itself on an output device using the Plot method 333 and calculate its distance from another CartesianPoint object using the Range method 336. When source code using the CartesianPoint object type is translated into data and executable instructions and then executed, each actual CartesianPoint object 340, 350 will have two integers of its own (corresponding to X and Y), but the Plot and Distance methods will be sequences of executable instructions 360, 370 shared among all the CartesianPoint objects. (The sample class shown in FIG. 3 is simplified to highlight the data/method distinction. It is appreciated that many OO languages permit the declaration of data fields that are shared by all instances and/or the definition of instance-specific methods.)

Corresponding to the two basic sorts of information an OO system keeps about an object, embodiments of the invention permit a developer to identify two types of key points in a program. One type of key point is the access (reading or writing) of a data field. The other type of key point is the invocation of a method. Key points are identified by “pointcut expressions,” described below. Embodiments obtain one or more pointcut expressions, then process an input code (for example, a source code file, an object code file, or a bytecode file) and produce a modified code with added instructions to cause a programmable processor to perform an interception function if the key point is encountered when the program is executed.

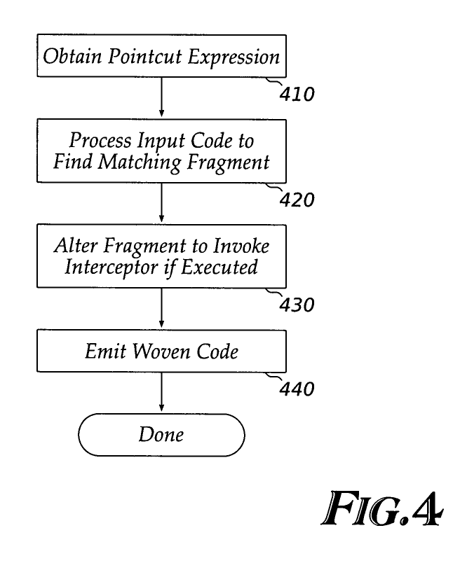

FIG. 4 is a flow chart outlining operations of an embodiment of the invention at a high level. First, the embodiment obtains a pointcut expression (410). The pointcut expression may come from a file, database, or other repository. In some embodiments, a hierarchically-structured text file, using a format such as the Extensible Markup Language (“XML”), may be used to provide the pointcut expressions and other information needed by an embodiment. Pointcut expressions often identify types, methods (including constructors), and data fields.

Next, an input code is processed to locate a fragment that matches the pointcut expression (420). As explained above, the input code may be the original source code of the program in the source language (e.g., C++ or Java); or it may be a compiled or linked object code or bytecode. Any input code may be used, as long as the code contains enough information to match the pointcut expression. Java bytecodes, in particular, carry much of the type information expressed in the original source code, so many pointcut expressions are valid for processing Java bytecodes.

When a fragment matching the pointcut expression is located, it is altered to cause the fragment to invoke an interceptor if the fragment is executed (430). Finally, an output code including part of the input code and the altered fragment is emitted (440). The modified output code is said to have been “woven” (by analogy to textile weaving: the inserted code is like the weft threads, while the input code is like the warp threads). The output code may subsequently be processed by a compiler, linker, class loader; or the like, so that the woven program can be executed.

Turning now to the pointcut expressions themselves, they are most useful when they permit the identification of key points in an object-oriented program that are not necessarily related through the class hierarchy or through another relationship system that is already supported by the underlying language. However, even pointcut expressions that merely provide another way to associate certain functionality with selected objects, fields and/or methods can be useful. It is appreciated that ultimately, actions performed by a programmable processor are controlled by a sequence of executable instructions, which can be produced in myriad ways. Embodiments of the invention improve the efficiency and code re-use potential of some of those ways.

In the following material, pointcut expressions and related specifications will be presented as Extensible Markup Language (“XML”) fragments. XML is a convenient form for storing and processing such information, and is familiar to those of skill in the art. An embodiment need not use XML, but XML's expressive power and ease of automatic handling make it a good choice in this application. The XML fragments shown here include line numbers for ease of reference in the descriptive text, but such line numbers should not be considered a part of the fragment.

A basic pointcut expression may match any data access:

Listing 1

10 <bind pointcut=“field(* *->*)”>
20 <interceptor class=“CountFieldAccess”/>
30 </bind>

This fragment instructs an embodiment to modify the program so that every data access (read or write) of an object field will trigger an invocation of the CountFieldAccess interceptor. (This would be computationally expensive, and of uncertain value, apart from pedagogical.) Note that the same interceptor function will be invoked for a field access of any class—to accomplish the same effect through traditional means would require the modification of every class that has data fields. This example implicitly suggests that a pointcut expression may include a wildcard value. In some embodiments, pointcut expressions may support full text-matching regular expressions. Pointcut expressions themselves are not independent XML constructs—they are merely strings for which XML provides a convenient framework to specify and manipulate. An embodiment of the invention may process the pointcut expression strings in any convenient manner. For example, as discussed above, pointcut expression strings may be treated as text-matching regular expressions.

Another pointcut expression may match any method execution:

Listing 2

10 <bind pointcut=“execution(* *->*(..))”>
20 <interceptor class=“CountMethodCalls”/>
30 </bind>

Programmers of even modest skill might suppose, correctly, that matching all method executions would result in an infinite recursion, as the interceptor intercepted its own methods. Care should be exercised to avoid this outcome. An embodiment that weaves Java programs may provide an interface or tag that can be placed on a class or method to prevent it from being woven; this is one way to avoid infinite recursion.

Although conceptually, key points are either data accesses or method invocations, a finer level of detail in pointcut expressions may be useful. Within data accesses, a useful distinction is whether the access is to read data or to write data. The following XML fragment presents two pointcut expressions; the first (lines 10-30) matches read accesses, and the second (lines 40-60) matches write accesses.

Listing 3

10 <bind pointcut=“get(WeatherReport->temperature)”>
20 <interceptor class=“ConvertCtoF”/>
30 </bind>
40 <bind pointcut=“set(UserAccount->password)”>
50 <interceptor class=“CheckStrength”/>
60 </bind>

The first interceptor (Listing 3, line 30) suggests one use for field interceptors: to convert data from one form to another, without modifying the code of an existing object. Here, a WeatherReport object includes a data member containing a temperature, and an embodiment of the invention may be used to ensure that the temperature is always reported in Fahrenheit, notwithstanding that it is stored in Celsius. The second interceptor (Listing 3, line 50) shows how a program could be augmented to ensure that the password stored in a UserAccount object meets a particular standard for security, without forcing that standard onto all programs that use the UserAccount object by encoding the standard in the object itself.

Pointcut expressions that match method invocations may also be subdivided into useful categories. For example, a constructor is a method that is invoked to prepare an object for use. This is often an important phase of an object's lifecycle, and so an embodiment may permit constructors to be designated specially:

Listing 4

10 <bind pointcut=“construction(MyClass->new( ))”>
20 <interceptor class=“ConstructAnInstanceOfMyClass”/>
30 </bind>

To permit more precision in identifying key points, an embodiment may support pointcut expressions that take other information about a class into account. For example, a pointcut may identify classes that implement a particular interface, or that have been marked with a particular tag. Furthermore, Boolean expressions of arbitrary complexity may be used in some embodiments. For example, the following XML fragment may be interpreted to mean that only methods named Print, returning a String value, that are called from within a class whose name includes the word “Paper,” should trigger an interceptor.

Listing 5

10 <bind pointcut=“within(*Paper*) AND
20 call(String *->Print(..))”>
30 <interceptor class=“LimitedInterceptor”/>
40 </bind>

The following table lists pointcut expressions that have been implemented in an embodiment and found to be useful. The specification and implementation of other pointcut expressions to match key points in a program are within the capabilities of one of ordinary skill in the relevant arts.

TABLE 1

| Example Syntax | Explanation |
|---|---|
| execution(method or constructor) | execution is used to specify that a method or |
| | constructor invocation is a key point. System |
| | classes cannot be used in an execution expression. |
| construction(constructor) | construction is used to specify that a |
| | constructor is a key point. In contrast to the |
| | execution pointcut, construction requires |
| | that any code that calls new( ) must be |
| | instrumented by the compiler. With |
| | construction the key points are woven within |
| | the constructor after all the other code in the |
| | constructor. Thus, interceptors are effectively |
| | appended to the code of the constructor. |
| get(field) | get is used to specify that a field access (read |
| | access) is a key point. |
| set(field) | set is used to specify that a field access (write |
| | access) is a key point. |
| field(field) | field is used to specify that a field access (either read |
| | access or write access) is a key point. |
| all(type) | all is used to specify any constructor, method or |
| | field of the named type (class) as a key point. |
| call(method or constructor) | call is used to specify a constructor or method as |
| | a key point. It differs from execution in that the |
| | interception happens on the caller's side, rather |
| | than the callee. |
| within(type) | within matches any constructor or method |
| | invocation within the named class. |
| withincode(method or constructor) | withincode matches any constructor or method |
| | invocation within the identified method or |
| | constructor. |
| has(method or constructor) | has states an additional requirement for |
| | matching: if a key point is matched, its class must |
| | also have a constructor or method that matches |
| | the identified method or constructor. |
| hasfield(field) | hasfield is similar to has: if a key point is |
| | matched, its class must also have a field (data |
| | member) that matches the identified field. |

The pointcut expressions described above are one way that a developer can identify a key point in a program. Another useful identification mechanism allows the developer to specify run-time conditions that will trigger an interceptor. Such conditions may be described generally as relating to control flow. Listing 6 shows one way control flow could be specified in an XML fragment.

Listing 6

10 <cflow-stack name=“TriggerOnRuntimeCondition”>
20 <called expr=“void Obj->method1( )”/>
30 <called expr=“void Obj->method2( )”/>
40 <called expr=“void Obj->method3( )”/>
50 </cflow-stack>
60 <bind pointcut=“execution(void Obj->target(int))”
cflow=“TriggerOnRuntimeCondition”>
70 <interceptor class=“OccasionalInterceptor”/>
80 </bind>

This fragment may be interpreted to mean that an invocation of the “target” method of an object should be intercepted only if it occurs while the methods “method1”, “method2” and “method3” have all been invoked before the “target” method.

Static pointcut expressions to indicate object types (classes), methods, data members and other non-functional program features; and dynamic control flow expressions to identify states that may occur while the woven program is executing, can be treated alike for many purposes of an embodiment of the invention. Pointcut expressions and control flow expressions will be referred to together as “aspect selectors”—they match one or more aspects of a program. An embodiment of the invention modifies an input code so that selected operations will be undertaken when an aspect match occurs.

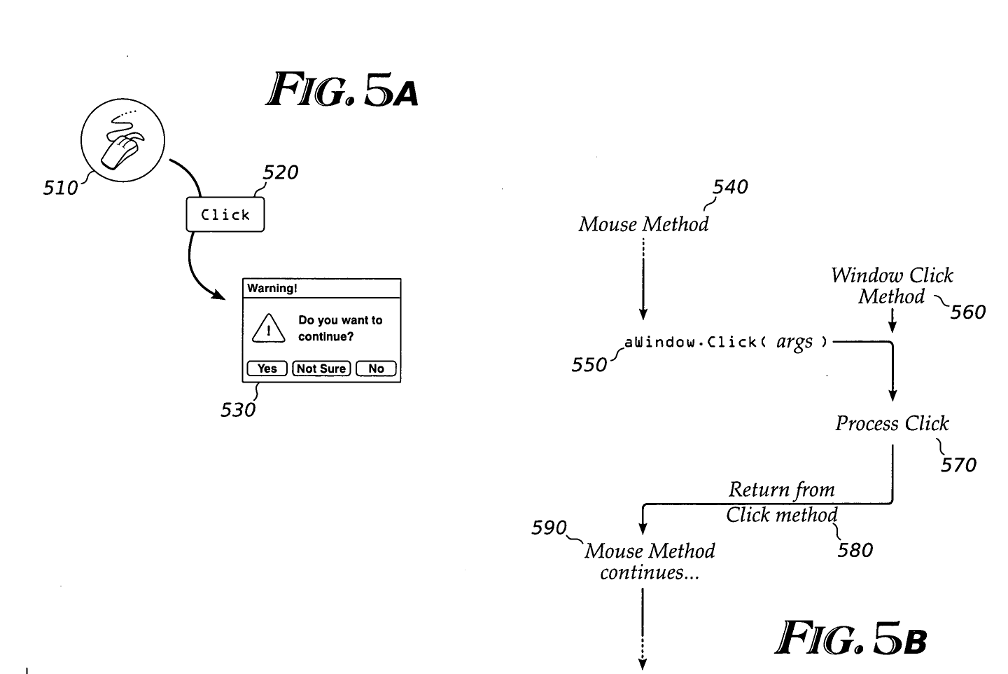

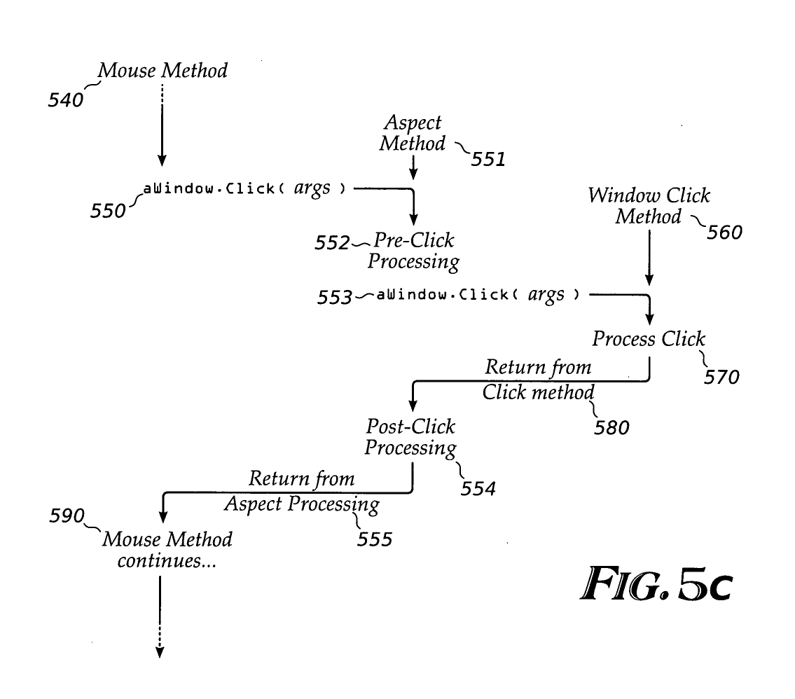

FIG. 5A shows an example of an abstract conception of object interactions in an object-oriented program: a first object 510 representing a computer pointing device or “mouse” sends a message 520 to a second object 530 representing a window displayed in a user interface. The Click message 520 may cause the window to perform some further action by sending messages to other objects. However, at a concrete level, those of skill in the relevant arts will understand that, as shown in FIG. 5B, a programmable processor will be executing instructions from a sequence of instructions of a method of the Mouse object 540; “sending the Click message” as shown at 520 actually corresponds to a subroutine call 550, which will cause the programmable processor to retrieve and execute instructions of the Window object's “Click” method 560. These instructions will perform any necessary processing to deal with a mouse click 570. Eventually, the “Click” method will return 580, and the processor will resume executing instructions from the Mouse object method 590.

FIG. 5C shows what may happen at the programmable processor level when an aspect selector identifies the Window object's Click method as a key point. As before, during the execution of a Mouse method 540, a Click message is sent by calling a subroutine of the Window object 550. An embodiment of the invention has processed an input code of the Mouse and/or Window objects and modified the code to cause additional processing shown here. Instead of retrieving and executing the Window's Click subroutine instructions, instructions of an aspect method 551 are executed. These instructions may perform pre-Click processing 552 before transferring control 553 to the Window's Click method 560. Also, when the Window's Click method 560 returns 580, the aspect method 551 may perform post-Click processing 554. Finally, upon return from aspect processing 555, the Mouse method's instructions resume 590. A single key point in a program may be matched by multiple aspect selectors. In this case, a nested set of aspect methods (interceptors) may be invoked between the woven program's calling and called methods.

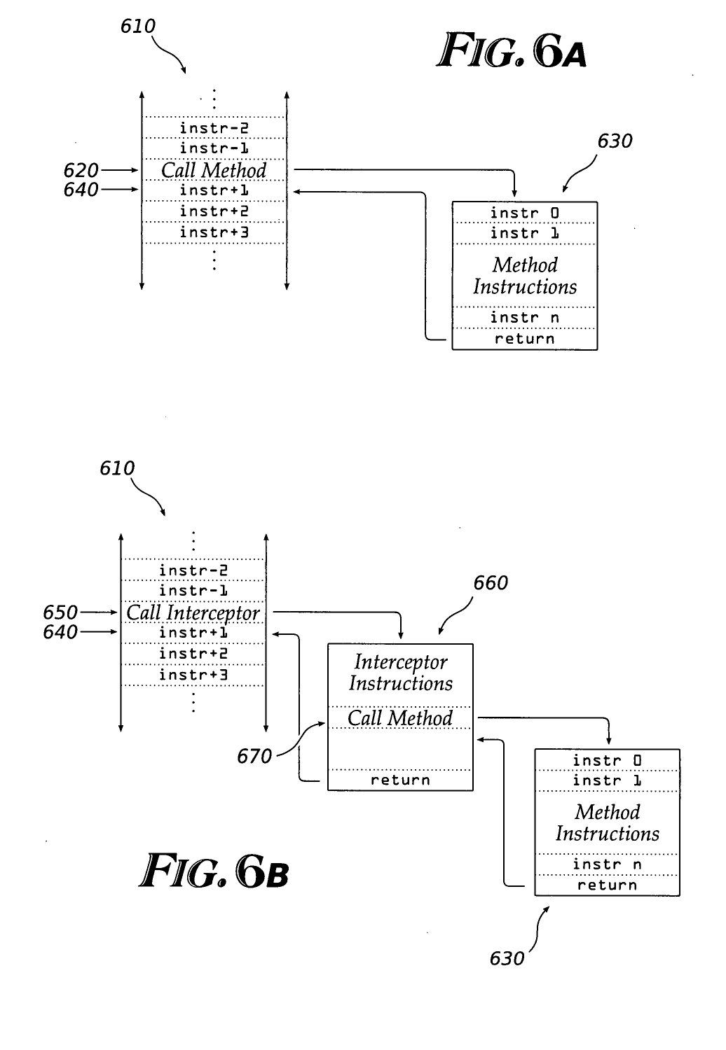

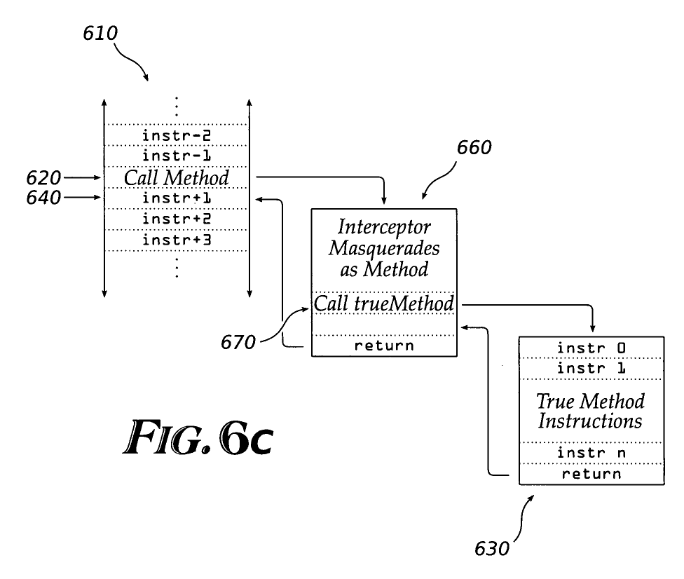

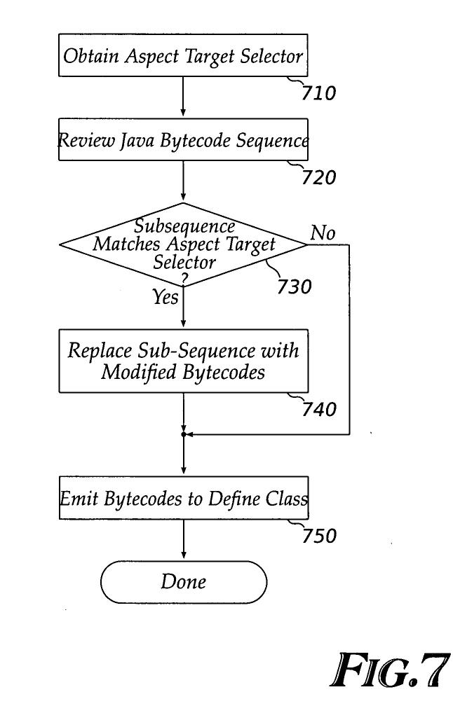

FIG. 6A shows a sample sequence of instructions of a program before weaving. A “caller” instruction sequence 610 includes an instruction 620 to invoke or transfer control to a “callee” instruction sequence 630. (In object-oriented parlance, the caller object is sending a message to the callee object.) When callee sequence 630 is finished, control returns to caller sequence 610 at instruction 640. FIGS. 6B and 6C show two possible ways that an embodiment may alter an input code to intercept the callee invocation that occurs as the processor executes instruction 620.

In FIG. 6B, instruction 620 may be modified to instruction 650, to transfer control to an interceptor management sequence 660. Interceptor 660 may perform runtime control flow processing and/or invoke one or more interceptor instruction sequences. A stack-like data structure (not shown) may be used so that multiple interceptors are nested. Less-nested interceptors may call more-nested interceptors, with the most-deeply-nested interceptor calling the original callee instruction sequence 630. When the callee returns, the interceptor(s) stacks are unwound and control returns to the caller sequence 610 at instruction 640. This modification may be used when the input code of the caller is available, but the input code of the callee is not.

In FIG. 6C, the caller instruction sequence 610 is not modified, but the callee instruction 630 sequence is hidden or wrapped by the interceptor instruction sequence 640. In effect, the interceptor instruction sequence 660 masquerades as the callee sequence 630, and transfers control to the true callee only after appropriately-nested interceptor functions are invoked. This modification may be used when the input code of the caller is not available, but the input code of the callee is. When all relevant input code is available, it is preferable to insert hooks into callees' instruction sequences, since a single modification there can intercept calls from anywhere.

Similar modifications can be made when a key point matches a data read or write operation. Data access is usually performed by an executable instruction that does not redirect flow control to another sequence of instructions. However, an embodiment of the invention can insert a flow-control-changing instruction and then treat the data access identically to a method invocation (as discussed with reference to FIGS. 6A-6C). The following pseudo-code listing fragments show a before-and-after-modification example:

Listing 7A

10 /* Deposit funds to account */
20 balance = balance + deposit;

might be replaced by:

Listing 7B

10 /* Deposit funds to account */
20 temp = getBalance( );
30 temp = temp + deposit;
40 setBalance( temp );

The “getBalance” and “setBalance” subroutine (method) calls may be automatically generated, and key points that match reading or writing the “balance” field may cause interceptors to be invoked when these generated methods are called.

It is easy to see how the input code modifications described above could be made during the compilation process, when the input source code (i.e., the original C++, Java or other object-oriented language code) is available. However, an embodiment of the invention may also function much later in the development-and-execution sequence. Such an embodiment is described here.

Java source code is usually compiled to produce lower-level bytecode sequences that can be executed by a virtual machine. Unlike the executable instruction sequences created when a language like C++ is compiled, however, Java bytecodes carry much of the class information present in the original source code. Consequently, an embodiment of the invention can match aspect selectors against bytecodes in a compiled Java module, and furthermore, can alter the sequence of bytecodes to invoke interceptor functions when a key point is encountered, before the bytecodes are loaded into the virtual machine for execution. Therefore, an embodiment can operate as outlined in FIG. 7: first, a joinpoint selector is obtained (710). The selector may be specified in an XML file using the same syntax described earlier. Next, a sequence of Java bytecodes is reviewed (720). If a subsequence of the Java bytecodes matches a joinpoint selector (730), the subsequence is replaced with a modified subsequence of bytecodes that invoke an interceptor associated with the joinpoint selector (740). The (possibly modified) subsequence of bytecodes is used to define a class within a Java virtual machine (750). If there are multiple joinpoints selected by expressions in the XML file, all are woven (operation 740) before the modified bytecodes are used to define a class (operation 750).

This embodiment permits various aspects of a program's execution to be woven at run time, simply by supplying a different XML file. A Java ClassLoader object is an ideal location to implement an embodiment of the invention, since a ClassLoader-type object (or a sub-class of that class of object) is used to load bytecodes into a virtual machine. Many Java runtime systems even provide a standard way to replace a default ClassLoader with a modified ClassLoader that implements an embodiment of the invention. For example, the java.system.class.loader system property can be set to refer to modified class loader, or the “-javaagent” command-line option can be used to similar effect. A third method, less favored, is to re-compile the default class loader (including in its source instructions to implement methods according to an embodiment) and place the resulting bytecodes in a file or directory so that they will be found and loaded before the default system class loader. The third method makes use of the nonstandard Java “-Xbootclasspath/p:<path>” command-line option.

Current versions of the Java language offer an “annotation” facility that permits arbitrary metadata to be attached to source code elements like class and method definitions. Annotations can be used to specify pointcuts using syntax similar to that discussed above. This permits information to control an embodiment of the invention to be incorporated in the source code of a program itself, rather than being relegated to an auxiliary XML file.

The preceding material has described in some detail the methods and considerations relevant to identifying key points in an object-oriented program, and the ways an embodiment can arrange for interceptor code to be invoked if a key point is encountered during the execution of the program. Now, attention is directed to the question of how an embodiment arranges to weave different instances of a class differently. Recall that the instructions of methods are shared between all instances of a class. Thus, modifying a class method to invoke an interceptor function would be expected to result in every instance of the class executing the same interceptors. This may be acceptable for some embodiments, but greater flexibility can be obtained by extending the methods described above further.

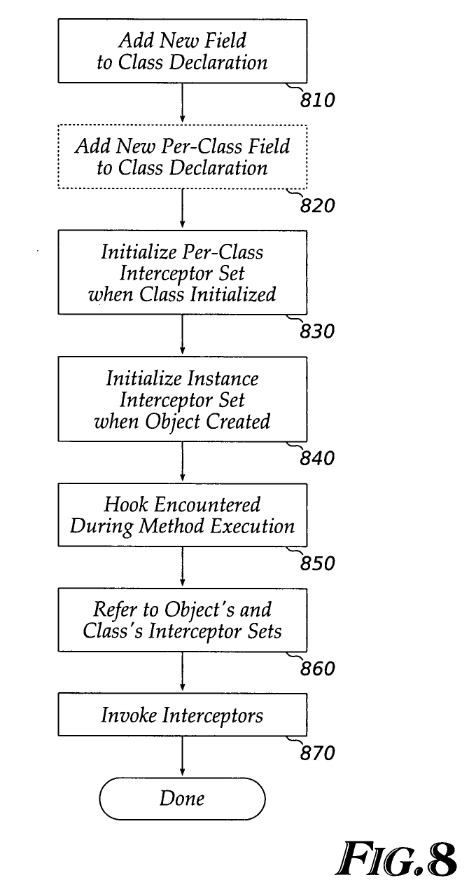

FIG. 8 outlines these additional operations to be performed while an input code is being processed. An additional data member (field) is added to the declaration of classes that have been selected for weaving in a pointcut expression (810). The additional data member can hold one or more interceptors. A “static” data member that is shared by all instances of the class may also be added (820). The static data member can also hold one or more interceptors. These two data members permit interceptors to be associated with a joinpoint of a single instance of the class, or with a joinpoint of every instance of the class. The interceptors may be organized as a single set associated with one (or every) instance; or as a plurality of sets (some of which may be empty), each set associated with a particular joinpoint.

When the class is loaded, the static interceptor set is initialized (830), and when an instance of the class is created, the instance's interceptor set is initialized (840). Finally, when a “hook” is encountered during execution of a method (850), the hook function refers to the object's and class's interceptor sets (860) and invokes any interceptors it finds there (850). The class-wide and instance-specific interceptor sets permit per-instance and per-class joinpoint interception.

Now, particular applications of embodiments that offer powerful new capabilities will be discussed. When an embodiment modifies an input code at some stage of processing between compiling, linking and/or loading, method hooks and interceptor data sets are inserted to permit an interceptor to be called when a key point of the program is reached. These hooks are accessible to the program itself while it is running. Thus, an embodiment can add or remove interceptors dynamically, on a per-class or even a per-instance basis. This capability permits the programmer to focus on an object or class over only part of its lifetime. For example, if an object is generally known to operate correctly, but exhibits a bug under certain circumstances, interceptors may be attached at key points of interest only while the object is executing under the problematic circumstances. This degree of control can significantly aid in debugging.

Another useful scenario is supported through a class loader embodiment. A software system may load libraries of classes to perform several distinct functions. For example, an application server framework may load one library of executable instructions to perform tax calculations and another library of executable instructions to perform shipping calculations. These libraries may contain some common classes, but the application server framework partitions the libraries into two sub-domains. A class loader embodiment can be used to weave and intercept only key points of classes and/or objects associated with one sub-domain, while classes and objects of the other sub-domain are unaffected. Sub-domains may be woven and instrumented differently, as well. A class loader can weave on a virtual machine (“VM”) basis, a package basis, a class basis, or an instance basis.

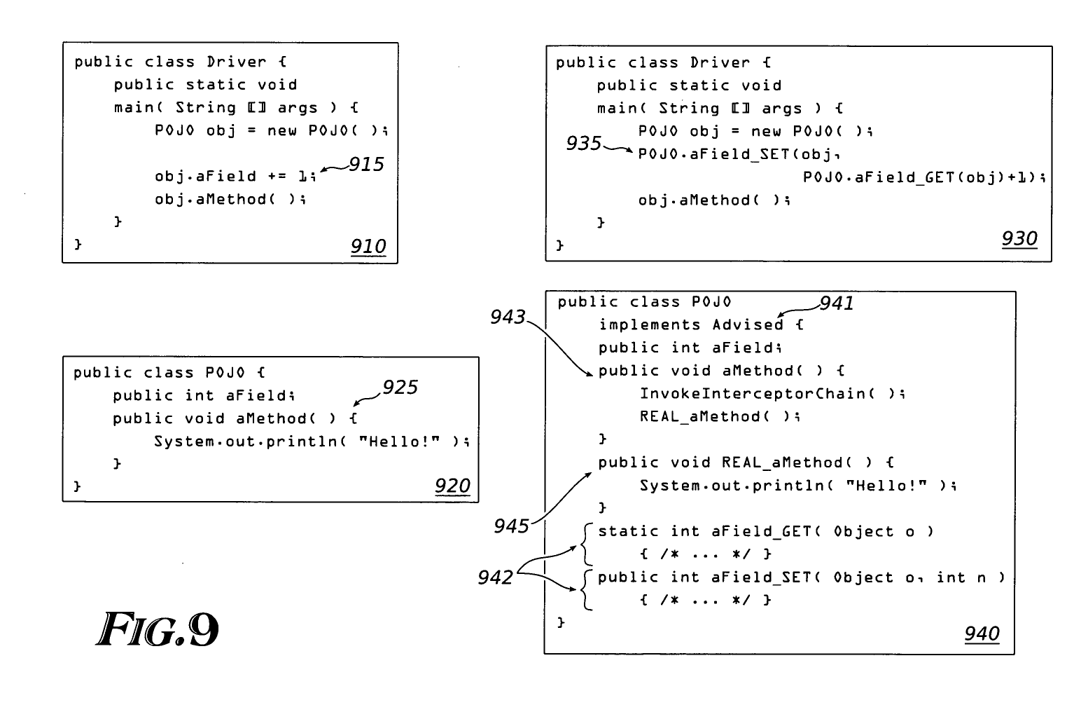

FIG. 9 shows some transformations made when weaving a simple Java source code program. The program includes two classes, a Driver class 910 and a Plain Old Java Object (“POJO”) class 920. The driver class simply creates a POJO, increments a data field of the POJO, and calls a method of the POJO.

An embodiment of the invention may process fragments 910 and 920 to produce fragments 930 and 940, respectively. In this example, the Driver code that increments a POJO field (at 915) is replaced by line 935, which uses automatically-generated GET and SET functions to accomplish the same incrementing operation. (The automatic generation of these GET and SET functions was also discussed earlier.)

The POJO code 920 undergoes several alterations shown at 940: first, an embodiment may add notation 941 to notify the compiler that the POJO class implements the “Advised” interface. (Those of skill in the arts will understand that most class, field and method names are arbitrary. Any legal identifier recognized by the language can be used. Names used in this example are chosen to suggest operations and functionality of other parts of the program that are not represented in this Figure.)

The automatically-generated GET and SET functions are shown at 942. As discussed in reference to FIG. 6C, the “aMethod” method is renamed to “REAL_aMethod” (945). The Driver function will call a new “wrapper” method 943, which performs interceptor processing before invoking the true aMethod subroutine.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Programs written in the Java programming language may be compiled to an intermediate form called “bytecode” that is interpreted by a run-time executive (“Java Virtual Machine” or “JVM”). Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In the preceding description, numerous details were set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions were presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals, etc.)), etc.

The applications of the present invention have been described largely by reference to specific examples and in terms of particular allocations of functionality to certain hardware and/or software components. However, those of skill in the art will recognize that per-class and per-instance aspects can also be woven by software and hardware that distribute the functions of embodiments of this invention differently than herein described. Such variations and implementations are understood to be captured according to the following claims.

I claim:

1. A method comprising:
obtaining an aspect target selector;
reviewing a sequence of Java bytecodes;
matching a subsequence of the Java bytecode sequence to the aspect target selector; and
replacing the subsequence with a modified subsequence to invoke an interceptor associated with the aspect target selector.

2. The method of claim 1, further comprising:
defining a class based on a modified sequence of Java bytecodes containing the modified subsequence.

3. The method of claim 1 wherein obtaining comprises:
reading the aspect target selector from an Extensible Markup Language (“XML”) file.

4. The method of claim 1 wherein the aspect target selector contains one of a type pattern, a method pattern, a constructor pattern or a field pattern.

5. The method of claim 1 wherein the aspect target selector contains a plurality of elements joined by Boolean operators, each element to match one of a type pattern, a method pattern, a constructor pattern or a field pattern.

6. The method of claim 1 wherein the aspect target selector matches a method invocation.

7. The method of claim 1 wherein the aspect target selector matches data loading operation or a data storing operation.

8. The method of claim 1 wherein the aspect target selector matches a call stack state.

9. A computer-readable medium containing data and instructions to cause a programmable processor to perform operations comprising:
defining a class loader object class;
creating an instance of the class loader object class;
instrumenting a target class loaded by the instance of the class loader object class according to a key point specifier;
creating an instance of the instrumented target class; and
intercepting one of an access of a field of the instance or an invocation of a method of the instance.

10. The computer-readable medium of claim 9 wherein the instance is a first instance, the medium containing additional data and instructions to cause the programmable processor to perform operations comprising:
creating a second instance of the instrumented target class;
accessing a field of the second instance without interception; and
invoking a method of the second instance without interception.

11. The computer-readable medium of claim 9, containing additional data and instructions to cause the programmable processor to perform operations comprising:
retrieving the key point specifier from an Extensible Markup Language (“XML”) repository.

12. The computer-readable medium of claim 9, wherein the instance of the class loader object class is to load a class in a first scope, and a default class loader object is to load the class in a second scope.

13. A computer-readable medium containing data and instructions to cause a programmable processor to perform operations comprising:
modifying a class reflection method to invoke a meta-interceptor if the class reflection method is accessed;
examining an object whose class is being accessed via reflection; and
invoking an interceptor for the object.

14. The computer-readable medium of claim 13, containing additional data and instructions to perform operations comprising:
removing an interceptor method from a list of methods of the object.

15. The computer-readable medium of claim 13 wherein the class reflection method is to obtain a set of methods implemented by class objects.

16. The computer-readable medium of claim 13 wherein the class reflection method is to obtain a set of data fields present in a class object.

17. The computer-readable medium of claim 13, containing additional data and instructions to perform operations comprising:
obtaining a pointcut specifier to identify one of a class, a class method or a class field, wherein
the invoking operation is performed only if the pointcut specifier matches a target of the reflection.
